(19) United States
(12) Patent Application Publication
(10) Pub. No.: US 2026/0126136 A1
(43) Pub. Date: May 7, 2026

(54) WALL PENETRATION COLLAR

(71) Applicants: Marcel Pennington, Pentiction (CA); Steven Dahl, sUMMERLAND (CA)

(72) Inventors: Marcel Pennington, Pentiction (CA); Steven Dahl, sUMMERLAND (CA)

(21) Appl. No.: 18/936,831

(22) Filed: Nov. 4, 2024

(51) Int. Cl. F16L 5/02; H02G 3/22

(52) U.S. Cl. CPC F16L 5/022; H02G 3/22

(57) ABSTRACT

An apparatus and method for protecting pipes or wires through a wall penetration wherein the apparatus comprises a base plate securable to a wall surface and a collar extending from the base plate and having a bore therethrough, the bore defining an interior passage through the apparatus. The method comprises securing the base plate to a wall surface and passing the pipes or wires through the interior passage. The collar may include a heat shrink material and the apparatus may further includes a sealing membrane adapted to overlay and seal around the base plate.

### BACKGROUND

### 1. Technical Field

This disclosure relates generally to construction and in particular to an apparatus and method for protecting articles penetrating through a wall.

### 2. Description of Related Art

In construction, it is frequently necessary to pass a pipe, wire or other object through the plane that is to define a wall. Such articles may be either passed through a hole formed in the wall or located in their desired position and the wall formed therearound. In the case of the later, it will be appreciated that the pipes or wires may need to be both protected from damage while the wall is being formed by drywall, tools or the like. It will also be appreciated that for use in many wall types, that it is also desirable to seal around the pipes or wires to reduce drafts, moisture and the like from passing through the wall at that location.

### SUMMARY OF THE DISCLOSURE

According to a first embodiment, there is disclosed an apparatus for protecting pipes or wires through a wall penetration comprising a base plate securable to a wall surface and a collar extending from the base plate and having a bore therethrough, the bore defining an interior passage through the apparatus.

The collar may include a front portion extending from a front surface of the base plate. The front portion may extend from the base plate by a distance equal to or less than to the thickness of a sheet of gyprock. The front portion may include tabs extending longitudinally from a distal end thereof. The tabs may be connected to the front collar so as to be selectably removable therefrom.

The collar includes a rear portion extending from a rear surface of the base plate. The rear portion may include at least one insulation injection port extending therethrough. The rear portion may include a fixed portion and a removable portion. The removable portion may be secuarable around the fixed portion. The removable portion may be radially compressible around the interior passage. The removable portion may be formed of a heat shrinkable material.

The apparatus may further comprise a guide tube connectable to the front portion, wherein the guide tub is operable to guide into and protect objects within the interior passage. The guide tube may be selectably removable from the front portion.

The apparatus may further comprise a sealing membrane, the sealing membrane formed of a sheet of material having front and rear surfaces and a bore therethrough, wherein the bore is sized to pass the collar therethrough.

The sealing membrane may have an outer perimeter equal to or larger than an outer perimeters of the base plate. The sealing membrane may be formed of a flexible material.

According to a first embodiment, there is disclosed a method for protecting pipes or wires through a wall penetration comprising securing a base plate to a wall surface, the base plate having a collar extending from the base plate and having a bore therethrough, the bore defining an interior passage through the apparatus and passing the pipes or wires through the interior passage.

The method may further comprise sealing between the pipes or wires and the bore. The collar may be heat shrunk around the pipes or wires. The method may further comprise applying a sealing membrane over the base plate to extend beyond the peripheral edge of the base plate and securing the sealing membrane to the wall surface.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The accompanying drawings constitute part of the disclosure. Each drawing illustrates exemplary aspects wherein similar characters of reference denote corresponding parts in each view,

FIG. 1 is a perspective view of an apparatus for protecting articles through a wall according to a first embodiment of the present disclosure located within a wall adjacent to a wall stud.

FIG. 2 is a perspective view of the apparatus for protecting articles through a wall according to a further embodiment of the present disclosure.

FIG. 3 is a cross sectional view of the apparatus of FIG. 2 as taken along the line 3-3.

FIG. 4 is a cross sectional view of the apparatus of FIG. 2 as taken along the line 4-4.

FIG. 5 is a front perspective view of the apparatus for protecting articles through a wall according to a further embodiment of the present disclosure.

FIG. 6 is a rear perspective view of the apparatus of FIG. 5.

FIG. 7 is an exploded rear perspective view of the apparatus of FIG. 5.

FIG. 8 is a cross sectional view of the apparatus of FIG. 5 as taken along the line 8-8.

FIG. 9 is a rear view of the base plate and fixed portion of the apparatus of FIG. 5.

FIG. 10 is an apparatus for protecting articles through a wall according to a further embodiment of the present disclosure.

FIG. 11 is an apparatus for protecting articles through a wall according to a further embodiment of the present disclosure.

FIG. 12 is a front perspective view of the apparatus for protecting articles through a wall according to a further embodiment of the present disclosure.

FIG. 13 is a cross sectional view of the apparatus of FIG. 12 as taken along the line 13-13.

FIG. 14 is an exploded view of the apparatus of FIG. 12.

FIG. 15 is a perspective view of the apparatus of FIG. 12 at a final or constricted position.

### DETAILED DESCRIPTION

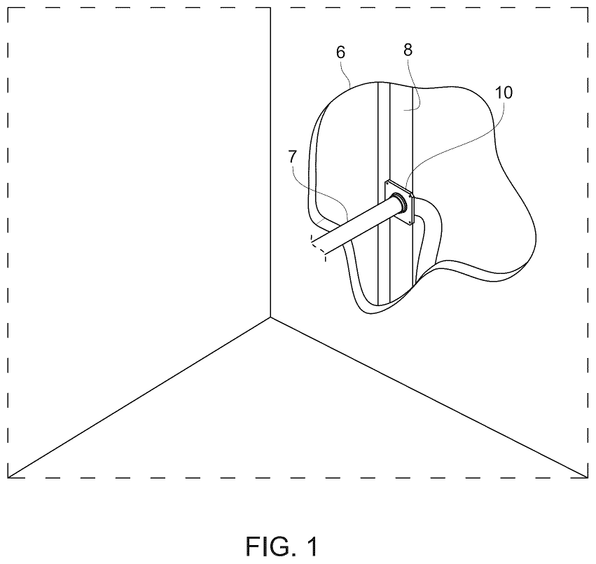

Aspects of the present disclosure are now described with reference to exemplary apparatuses, methods and systems. Referring to FIG. 1, an exemplary apparatus for protecting articles passing through a wall according to a first embodiment is shown generally at 10. As illustrated the apparatus 10 may be secured to a stud 8 behind sheathing material 6, such as gyprock or the like. As illustrate, the apparatus 10 is secured to the wall stud 8 and wires, pipes or the like are passed therethrough. Thereafter, the sheathing material is applied to the wall around the apparatus so as to retain the passage through the apparatus through the wall as will be more fully described below. As utilized herein, the term wall surface may refer to any surface, either external or internal, that is formed by or forms part of a wall, including, without limitation, a surface of a wall stud, an interior or external surface of a sheathing material or a surface of a layer or membrane used in forming the wall.

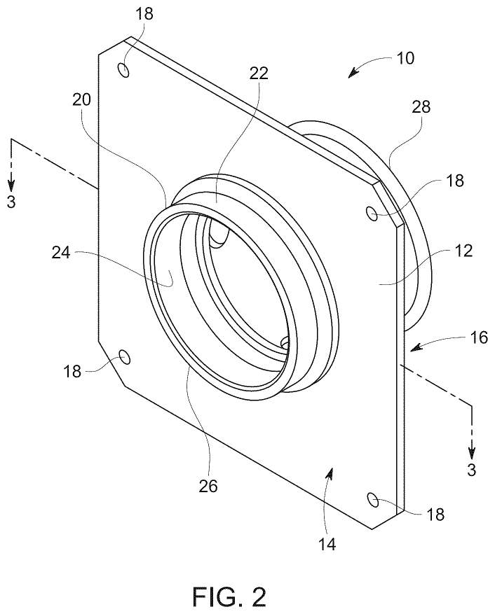

Turning now to FIG. 2, the apparatus 10 comprises a base plate 12 having a collar 20 extending therefrom. The collar 20 defines a passage 32 therethrough sized to pass the desired articles, such as pipes, wires or the like. By way of non-limiting example, the passage may be any desired size, such as, by way of non-limiting example between 1 and 4 inches (25 and 102 mm) for residential construction purposes although it will be appreciated that other sizes may also be utilized for industrial, commercial or other uses.

The base plate 12 may be of any suitable shape including square, as illustrated herein by way of non-limiting example. The base plate 12 includes front and rear surfaces, 14 and 16, respectively. The base plate 12 may further include mounting bores 18 extending therethrough for securing to a wall stud 8 or the like. In particular, the base plate 12 may include mounting bores 18 in each or only some of the corners of the base plate as illustrated.

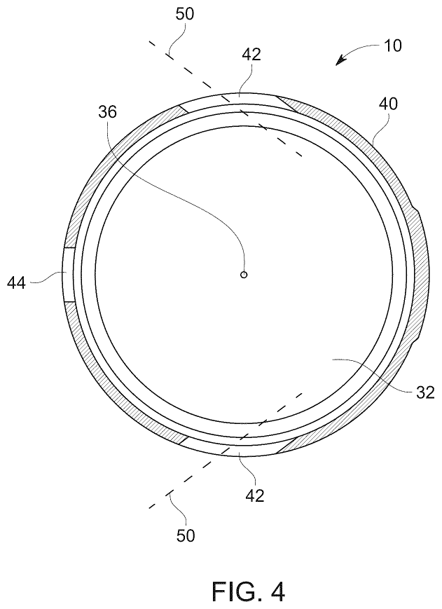

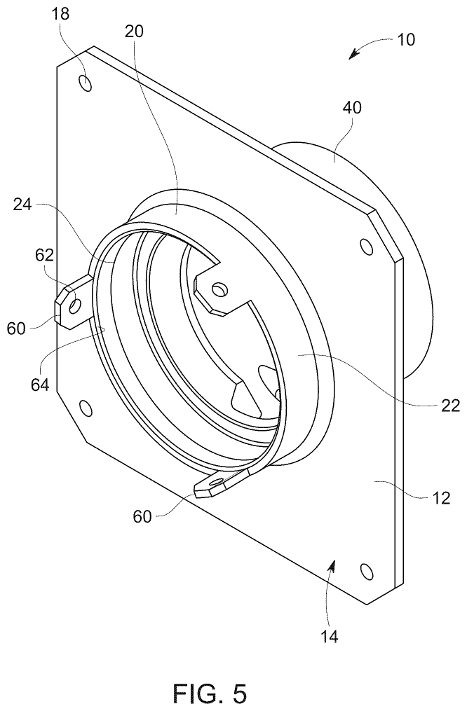

The collar 20 may be substantially cylindrical and extends through the base plate and away from each of the front and rear surfaces 14 and 16. It will be appreciated that other shapes for the collar 20 may also be utilized. The collar is defined between inner and outer surfaces, 22 and 24, respectively, and extending between front and rear distal ends, 26 and 28, respectively. The collar 20 includes a front portion 30 extending between the front surface 14 and the front distal end 26 and a rear portion 40 extending between the rear surface 16 and the rear distal end 26. The front portion 30 has a distance between the front surface 14 and the front distal end 26 selected to correspond to the thickness of the intended sheathing material, such as by way of non-limiting example, ½ inch (12 mm) for use with standard ½ inch gyprock. Turning now to FIG. 4 the passage 32, as defined by the inner surface 22 may tapered towards the front distal end 26 by a taper angle generally indicated at 34 so as to assist in the receipt and retention of a pipe 7 therein. As illustrated, the passage 32 may extend along a passage axis 36. As illustrated in FIG. 5, the front distal end 26 may include one or more tabs 60 extending therefrom. The tabs 60 may include a bore 62 therethrough for securing the pipe 7 or other object therein. The tabs 60 may be connected to the collar 20 along a frangible, perforated or other weakened connection line 64 so as to facilitate removal for finishing the wall surface.

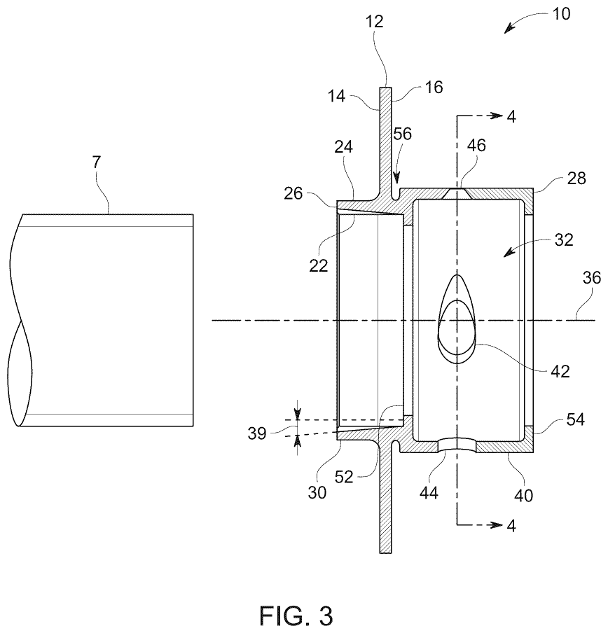

The rear portion 40 includes a plurality of apertures 42 and 44 extending between the inner and outer surfaces 22 and 24. In particular the apertures may include injection apertures 42 and 44. The injection apertures 42 may be located at any other location around the collar and are utilized to inject spray in insulation or the like into the passage 32. As illustrated, two injection apertures 42 may be utilized, although it will be appreciated that other quantities may also be provide as well. The injection apertures 42 may each be aligned along an axis 50 so which may optionally be oriented with respect to an axis oriented substantially tangential to the passage axis 36 thereby permitting the injected insulation at an angle to the passage thereby assisting distribution therein. It will be appreciated that the tool passage 44 may also be utilized for injecting insulation or the like. As illustrated in FIG. 3, the rear portion 40 may include annular walls 52 and 54 extending radially inward proximate to the base plate 12 and the rear distal end 26 so as to assist with retaining any insulation injected into the passage 32. Furthermore, the rear portion 40 may include an annular groove 56 around the periphery thereof to permit the removal of the rear portion 40 from the base plate 12 at installations where the rear portion is not needed or may be obstructing another object within the wall.

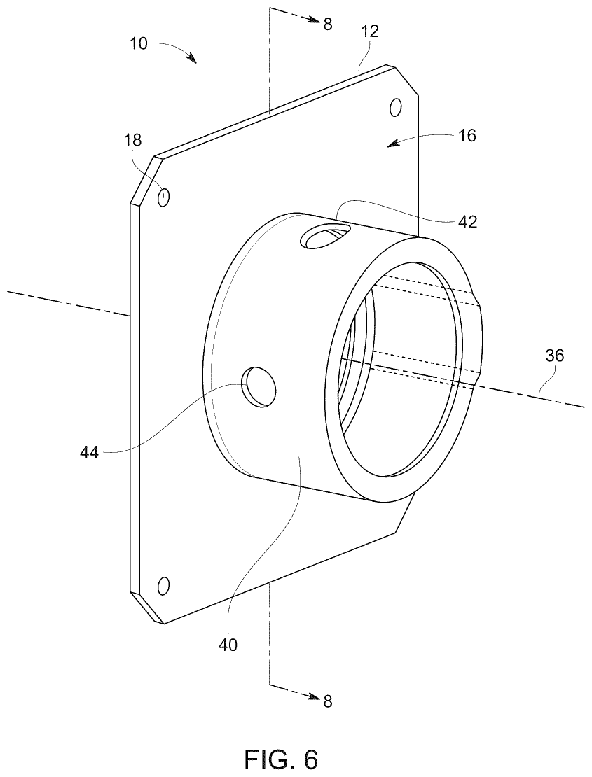

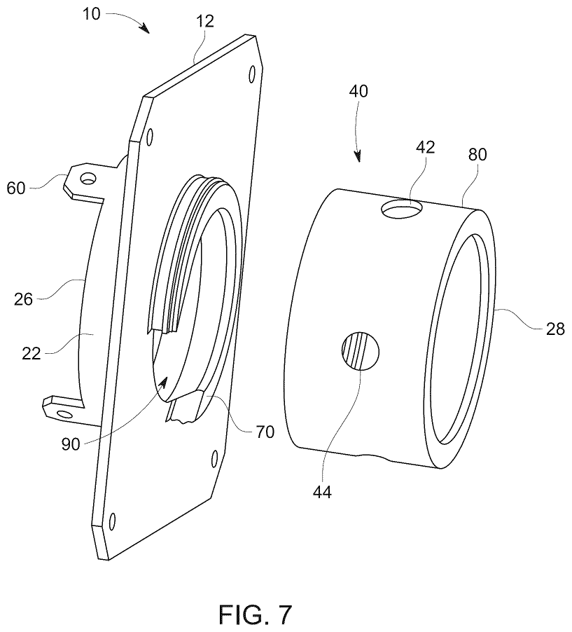

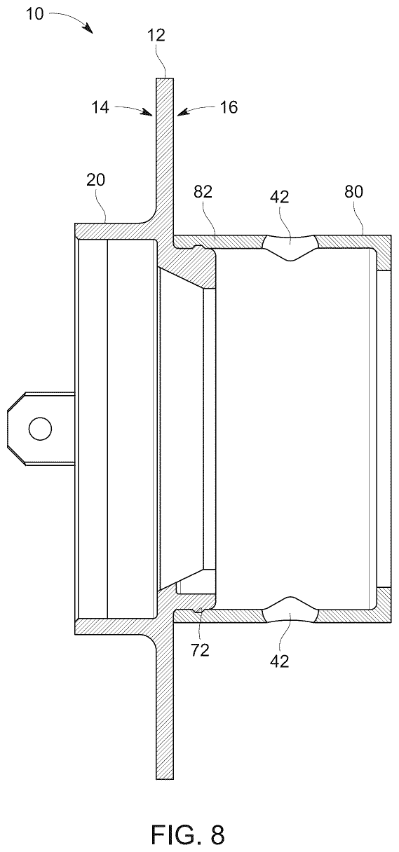

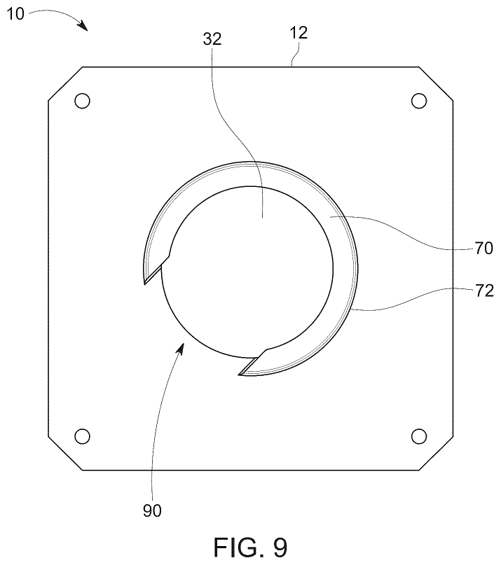

Turning now to FIGS. 6 through 9, according to an alternative embodiment, the rear portion 40 of the collar 20 may comprise a fixed portion 70 secured to the base plate 12 and a removable portion 80 selectably connectable thereto. As illustrated, the removable portion 80 may be sized to surround the fixed portion and be secured thereover in axial alignment. The fixed portion 70 may include an annular ridge 72 extending outwardly therefrom at position and having a sized corresponding to an annular groove 82 located into the inner surface 22 of the removable portion 80. Optionally, the rear portion 40 or the fixed portion, as illustrated in FIGS. 7 and 9 may include a radial notch 90 therein so as to permit pipes, wires or the like to be turned prior to the rear distal end 26.

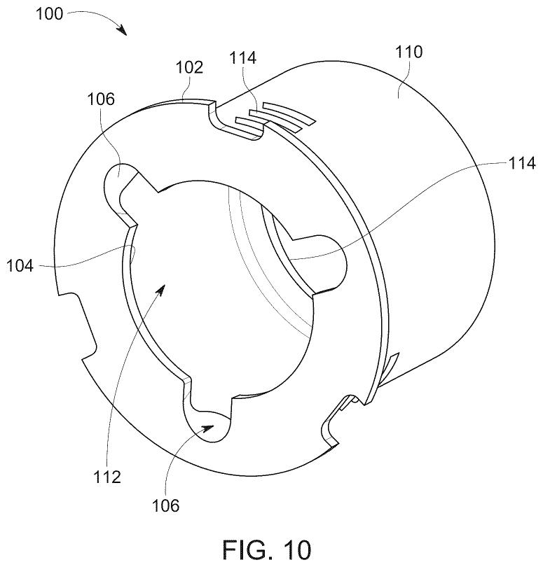

Turning now to FIG. 10, a further embodiment of the present disclosure is illustrated generally at 100. The apparatus 100 comprises a base plate 102 with an opening bore 104 therethrough having a collar 110 extending from the rear thereof defining a passage 112. A distal end of the collar 110 may annular walls 114 extending radially inward so as to assist with retaining any insulation injected into the passage 112. The base plate may include notches 106 therethrough around the aperture operable to permit spray foam or other materials into the passage 112. The opening bore 104 and an opening through the annular walls 114 may be smaller than the inner diameter through the collar 110. The outer wall of the collar 110 may include projections, such as by way of non-limiting example barbs on an exterior surface thereof adapted to engage a wall surface and secure the apparatus therein when passed through an opening in a wall.

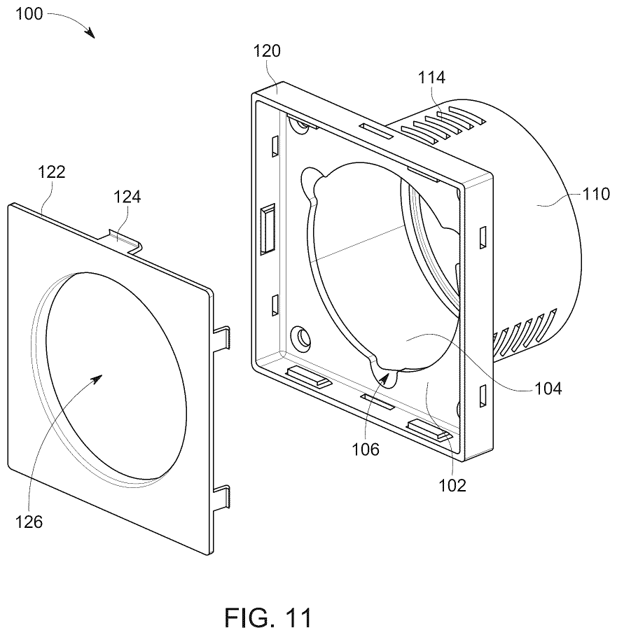

Turning now to FIG. 11, the apparatus 100 may further include a box formed with and extending from the base plate 102. The box 120 may be of any desired shape and may include a cover 122 engagable therein so as to contain volume within the box 120. The cover may include an opening 126 to permit pipes or wires to pass therethrough and may be formed of one or more portions as illustrated in FIG. 11. The cover may be retained within the opening of the box by tabs 124 or the like as are known.

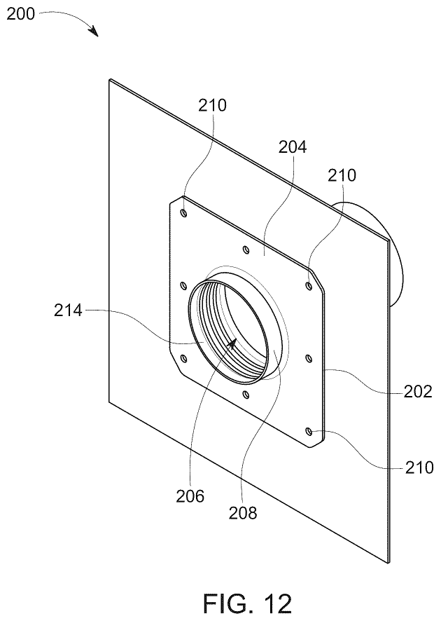

Turning now to FIGS. 12 through 14, a further embodiment of the present invention according to a further embodiment is illustrated. As illustrated in FIGS. 12 through 14, the apparatus 200 may comprise a base plate 202 and a selectably compressible tube 230 extending thereform. The base plate 202 may comprise a planar member 204 having any desired outline. As illustrated in FIG. 12, the planar member 204 may be substantially square although it will be appreciated that other shapes may be utilized as well. The planar member 204 includes a bore 206 therefore sized to receive one or more pipes or wires therethrough as selected by a user. The planar member 204 may include one or more mounting bores 210 extending therethrough for securing the apparatus to a wall stud or sheathing as are commonly known.

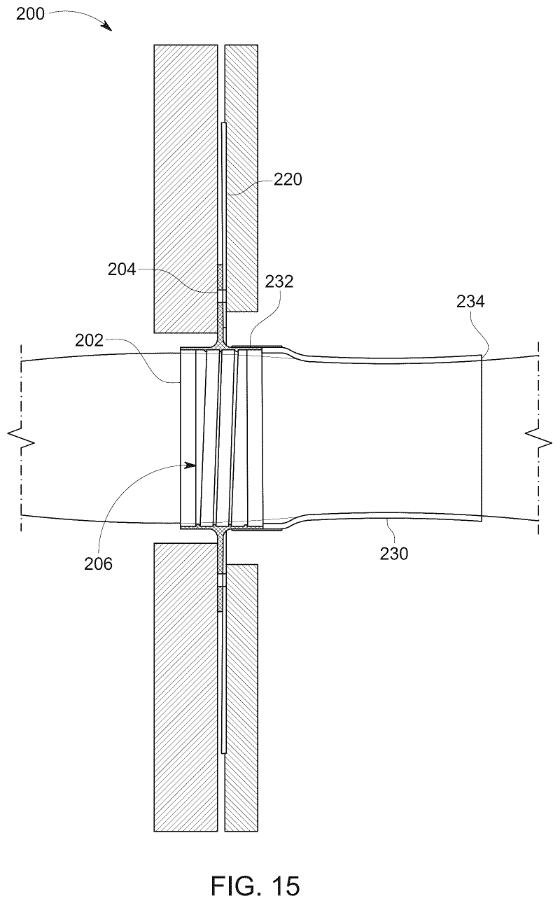

As illustrated in FIGS. 12-15 , the base plate 202 may include a tubular extension to the front and rear, 212 and 216, respectively of the planar member 204. The front tubular extension 212 may extend from the base plate 202 by a distance selected to be less than or equal to a thickness of a sheet of gyprock or other suitable sheathing material to be used to form the wall. The tubular extensions surround and define the bore 206. Optionally, the tubular extensions may include threading 214 therein for receiving pipes or other bodies threadably secured thereto.

Optionally, the base plate 202 may include a sheet of flashing 220 securable to or locatable between the planar member and one of the layers forming a wall. The sheet of flashing 220 may be larger than the planar member 204 so as to seal a greater area of the wall. Optionally, the sheet of flashing 220 may be of equal size to the base plate 202. The sheet of flashing 220 includes a bore 222 therethrough sized to surround the tubular extensions 212 or 2016 or the bore 206. The sheet of flashing 220 may be secured to the planar member 204 with adhesives, heat bonding or any other suitable method. The sheet of flashing 220 may be formed of any flexible material operable to underlay and seal around the base plate such as rubber, plastic, or the like.

The compressible tube 230 comprises a tubular member extending between first and second ends 232 and 234, respectively, The compressible tube 230 is formed of a selectably compressible material adapted to compress or shrink around the pipes 7 or wires extending therethrough. The compressible tube 230 may be formed of a heat shrinkable material so as to be operable to be shrunk around the pipes 7 or wires when exposed to a heat source. Examples of such heat shrink materials are well known. The base plate 202 and rear tubular extension 214 may be formed of any material and in particular may be formed of materials operable to be moulded and furthermore adherable to the compression tube 230. Examples of such materials, include acrylonitrile butadiene styrene, by way of non-limiting example.

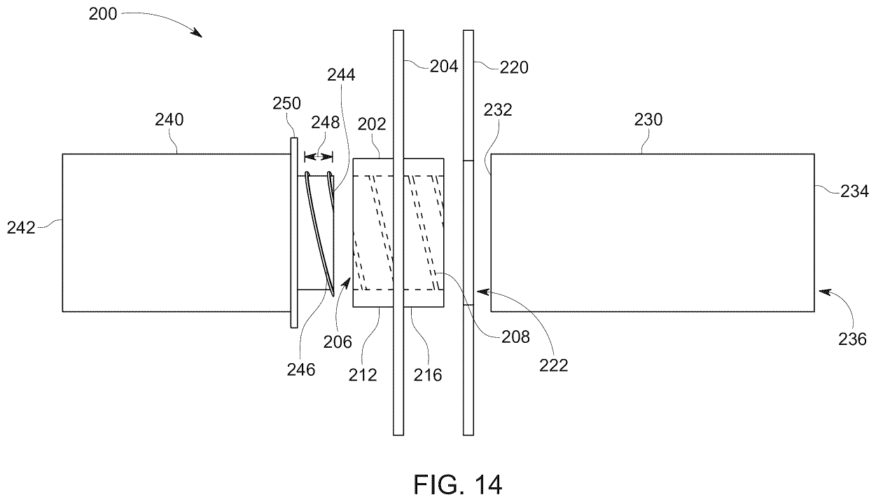

Optionally, the apparatus 200 may include a pipe protection collar 240. The pipe protection collar 240 extends between first and second ends 242 and 244, respectively, and is securable into the front end of the tubular extension. The second end 242 of the pipe protection collar 240 may include external threating 246 adapted to correspond to internal threading 208 on the inside of the bore 206. As illustrated in FIG. 14, the threading may have a thread spacing 248 selected to be wider than the thickness of the threading protrusions such that a loose connection is formed therebetween permitting a degree of rotation and movement therebetween and also to thereby reduce risk of cross threading. In particular the spacing 248 between the threading ridges may be 2 or a greater multiple wider than the thickness of the protrusions. The threading may thereafter be tightened until a shoulder 250 proximate to the second end 242 abuts the end of the front tubular extension 212. In operation, the pipe protection collar 240 may be secured around pipes passed through the bore 206 during construction to protect them from impacts or external forces until after construction is complete whereupon the pipe protection collar may be removed from the bore 206 and the wall surface completed.

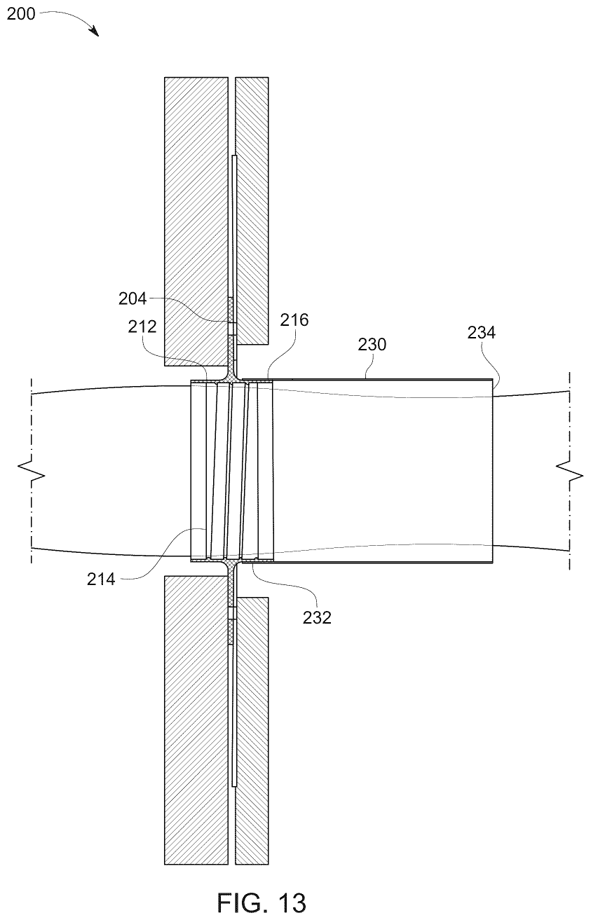

In operation, the sheet of flashing 220 may be secured to the planar member by any suitable means and the planar member 204 secured to the wall with the bore 206 or tubular extension 212 and/or 216 aligned therewith. As illustrated in FIG. 13, the first end 232 of the compressible tube 230 may be secured around the rear tubular extension 216. After the pipe or wires are passed through the bore 206 a heat source may be applied to shrink or compress the compressible tube therearound.

While specific embodiments have been described and illustrated, such embodiments should be considered illustrative only and not as limiting the disclosure as construed in accordance with the accompanying claims.

1. An apparatus for protecting pipes or wires through a wall penetration comprising:
a base plate securable to a wall surface;
a collar extending from the base plate and having a bore therethrough, the bore defining an interior passage through the apparatus; and
a guide tube threadably connectable within the interior passage, wherein the guide tub is operable to guide into and protect objects within the interior passage,
wherein the guide tube is selectably removable from the collar at any time before, during or after installation of pipes or wires through the interior passage.

2. The apparatus of claim 2 wherein the collar includes a front portion extending from a front surface of the base plate.

3. The apparatus of claim 2 wherein the front portion extends from the base plate by a distance equal to or less than to the thickness of a selected sheet of gyprock.

4. The apparatus of claim 2 wherein the front portion includes tabs extending longitudinally from a distal end thereof.

5. The apparatus of claim 4 wherein the tabs are connected to the front collar so as to be selectably removable therefrom.

6. The apparatus of claim 1 wherein the collar includes a rear portion extending from a rear surface of the base plate.

7. The apparatus of claim 6 wherein the rear portion included at least one insulation injection port extending therethrough.

8. The apparatus of claim 6 wherein the rear portion includes a fixed portion and a removable portion.

9. The apparatus of claim 8 wherein the removable portion is secuarable around the fixed portion.

10. The apparatus of claim 8 wherein the removable portion is radially compressible around the interior passage.

11. The apparatus of claim 8 wherein the removable portion is formed of a heat shrinkable material.

12. (canceled)

13. (canceled)

14. The apparatus of claim 1 further comprising a sealing membrane, the sealing membrane formed of a sheet of material having front and rear surfaces and a bore therethrough, wherein the bore is sized to pass the collar therethrough.

15. The apparatus of claim 14 wherein the sealing membrane has an outer perimeter equal to or larger than an outer perimeters of the base plate.

16. The apparatus of claim 15 wherein the sealing membrane is formed of a flexible material.

17. A method for protecting pipes or wires through a wall penetration comprising:
securing a base plate to a wall surface, the base plate having a collar extending from the base plate and having a bore therethrough, the bore defining an interior passage through the apparatus;
threadably connecting a guide tube within the interior passage, wherein the guide tub is operable to guide into and protect objects within the interior passage,
passing the pipes or wires through the interior passage, and
removing the guide tube from the collar after installation of pipes or wires through the interior passage.

18. The method of claim 17 further comprising sealing between the pipes or wires and the bore.

19. The method of claim 18 wherein the collar is heat shrunk around the pipes or wires.

20. The method of claim 17 further comprising applying a sealing membrane over the base plate to extend beyond the peripheral edge of the base plate and securing the sealing membrane to the wall surface.
